(19) United States
(12) Patent Application Publication
(10) Pub. No.: US 2023/0315050 A1
(43) Pub. Date: Oct. 5, 2023

(54) CONFORMAL COOLING CHANNEL DESIGN METHOD USING DEEP LEARNING AND TOPOLOGY OPTIMIZATION DESIGN

(71) Applicant: SFS Co., Ltd., Ulsan (KR)

(72) Inventors: Sungwoo BAE, Ulsan (KR); Heonjae CHOO, Ulsan (KR); Hyojae JANG, Ulsan (KR); Yongsuk BARK, Seoul (KR); Yejin JEONG, Ulsan (KR); Seunghyun YU, Ulsan (KR)

(21) Appl. No.: 17/762,493

(22) PCT Filed: Mar. 14, 2022
(86) PCT No.: PCT/KR2022/003511

§ 371 Date: Mar. 22, 2022

(30) Foreign Application Priority Data
Mar. 11, 2022 (KR) 10-2022-0030717

(51) Int. Cl. G05B 19/4155

(52) U.S. Cl. CPC G05B 19/4155; G05B 2219/45244

(57) ABSTRACT

Disclosed is a conformal cooling channel design method using deep learning and a topology optimization design. The conformal cooling channel design method using deep learning and a topology optimization design according to an embodiment of the present invention includes the steps of: classifying a molded product as a thin structure or a bulk structure, and determining a cooling target area; decomposing the cooling target area into cooling target surfaces of two-dimensional shape; producing a preprocessed image by performing a preprocessing step on an image of the cooling target surface to which a thermal load is reflected; forming cooling channels independent from each other, to which a topology optimization design is applied, for each of the cooling target surfaces by inputting the preprocessed image into a previously trained neural network; and forming a conformal cooling channel by combining the cooling channels.

### TECHNICAL FIELD

The present invention relates to a conformal cooling channel design method, and more specifically, to a conformal cooling channel design method using deep learning and a topology optimization design.

### BACKGROUND ART

Injection molding is a technique of mass-producing molded products of various shapes by injecting molten resin into a mold, and this is one of widely used plastic product production methods.

The injection molding process produces products through a filling process of filling a mold with molten resin, a pressure holding process of maintaining pressure inside the mold to be constant after filling the mold with molten resin, a cooling process of cooling the filled molten resin for a predetermined period of time, and a release process of taking out a molded product after cooling.

In the injection molding process, the cooling process occupies about 70% of the molding cycle, and quality of the molded product is greatly affected by uniformity of temperature after cooling the filled resin.

Since the cooling effect is excellent as a cooling channel is closer to the surface of a mold that defines the outer appearance of a molded product, a conformal cooling channel that follows the outer appearance of the molded product is used.

However, it is difficult to form a conformal cooling channel of a complex shape inside a mold in a conventional processing method. However, as a 3D printer may output a product having a hollow structure of a complex shape, a mold having a conformal cooling channel formed therein may be output through the 3D printer.

However, even when a conformal cooling channel is formed inside a mold, there is a problem in that the resin filled in the mold is not uniformly cooled.

Accordingly, a method of designing a conformal cooling channel that optimizes cooling efficiency is required.

### DISCLOSURE OF INVENTION

### Technical Problem

An object of a conformal cooling channel design method using deep learning and a topology optimization design according to an embodiment of the present invention is to provide a method of designing a conformal cooling channel inside a mold, after determining a cooling target surface by classifying a molded product as a bulk or thin structure and forming an independent cooling channel, to which the topology optimization design is applied, for each cooling target surface using deep learning of a neural network.

The problems of the present invention are not limited to the technical problems mentioned above, and other unmentioned technical problems will be clearly understood by those skilled in the art from the following description.

### Technical Solution

To accomplish the above object, according to one aspect of the present invention, there is provided a conformal cooling channel design method using deep learning and a topology optimization design, the method comprising the steps of: classifying a molded product as a thin structure or a bulk structure, and determining a cooling target area; decomposing the cooling target area into cooling target surfaces of two-dimensional shape; producing a preprocessed image by performing a preprocessing step on an image of the cooling target surface to which a thermal load is reflected; forming cooling channels independent from each other, to which a topology optimization design is applied, for each of the cooling target surfaces by inputting the preprocessed image into a previously trained neural network; and forming a conformal cooling channel by combining the cooling channels.

Here, the step of producing a preprocessed image may include the steps of: generating a second image by converting the image of the cooling target surface, to which the thermal load is reflected, into a gray scale image; generating a third image by performing histogram equalization on the second image; generating a binarized fourth image by performing binarization/thresholding on the third image; and detecting a contour of the fourth image, wherein the preprocessed image may be an image of which the contour is detected.

Here, the neural network may be a Convolutional Neural Network (CNN).

Here, the neural network may be trained using a plurality of learning data, and the learning data may include a learning image to which a thermal load is reflected, and shape data of a cooling channel formed using a topology optimization design for the learning image.

Here, the topology optimization design may include the steps of: setting a design domain; setting boundary conditions corresponding to operating conditions of the design domain; setting an objective function corresponding to minimization of pressure drop of cooling fluid at an inlet and an outlet, and cooling time up until an ejection temperature; and changing design variables so that the objective function satisfies a convergence condition.

Here, at the step of determining a cooling target surface, the molded product may be classified as a thin structure when a characteristic length of the molded product is smaller than 0.06.

### Advantageous Effects

According to the embodiments of the present invention, at least the following effects may be expected.

According to the present invention, a conformal cooling channel inside a mold with excellent pressure drop, cooling time, and cooling uniformity may be designed using a topology optimization design.

In addition, as a cooling target surface is determined after classifying a molded product as a bulk or thin structure, and a conformal cooling channel is designed after forming a cooling channel, to which a topology optimization design is applied, for each cooling target surface, conformal cooling channels with good performance can be designed relatively quickly.

In addition, as a neural network forms a conformal cooling channel through learning from an image of a cooling target surface to which a thermal load is reflected, the design time can be greatly reduced.

The effects according to the present invention are not limited by the contents exemplified above, and further various effects are included in this specification.

### BRIEF DESCRIPTION OF THE DRAWINGS

FIG. 1 is a flowchart illustrating a conformal cooling channel design method using deep learning and a topology optimization design according to an embodiment of the present invention.

FIG. 2 is a view illustrating a characteristic length for classifying the shape of a molded product.

FIGS. 3A-3B are views showing the measurement graphs of the average cooling time up until an ejection temperature and the maximum temperature deviation according to the shape of a molded product.

FIGS. 4A-4B are views describing a shape decomposition step.

FIG. 5 is a flowchart illustrating a preprocessed image production step.

FIG. 6 is a flowchart illustrating an independent cooling channel forming step.

FIGS. 7A-7D are views showing a conformal cooling channel forming step.

FIGS. 8A-8B are views showing examples of the conformal cooling channel of Experimental Example 1 and results of average pressure drop simulation.

FIG. 9 is a view showing the measurement graph of the maximum temperature deviation of the conformal cooling channel of Experimental Example 1.

FIGS. 10A-10B are views showing examples of the conformal cooling channel of Experimental Example 2 and results of average pressure drop simulation.

FIG. 11 is a view showing the measurement graph of the maximum temperature deviation of the conformal cooling channel of Experimental Example 2.

FIG. 12 is a view showing the conformal cooling channels of Experimental Example 3.

FIGS. 13A-13B are views showing a result of measuring the maximum/minimum temperature difference on the surface of the molded product of Experimental Example 3.

FIG. 14 is a view showing a result of measuring the cooling time up until the ejection temperature of Experimental Example 3.

### BEST MODE FOR CARRYING OUT THE INVENTION

Since the present invention may apply various transformations and have various embodiments, specific embodiments are illustrated in the drawings and described in detail in the detailed description. Effects and features of the present invention and a method for achieving them will become apparent with reference to the embodiments described below in detail together with the drawings. However, the present invention is not limited to the embodiments disclosed below, but may be implemented in various forms, and it should be understood to include all changes, equivalents, and substitutes included in the spirit and scope of the present invention.

Before describing the present invention, the terms disclosed in the detailed description will be described. In the following embodiments, terms such as first, second, and the like are used for the purpose of distinguishing one component from other components, not in a limiting sense. Accordingly, it goes without saying that a first component mentioned below may be a second component within the spirit of the present invention. In addition, a singular expression includes plural expressions unless the context clearly dictates otherwise. In addition, terms such as ‘comprise’ or ‘have’ mean existence of a feature, a number, a step, an operation, a component, a part, or a combination thereof described in the specification, and it does not preclude in advance the possibility that one or more other features or components may be added.

In addition, the size of the components in the drawings may be exaggerated or reduced for convenience of explanation. For example, since the size and thickness of each component shown in the drawings are arbitrarily shown for convenience of explanation, the present invention is not necessarily limited to the description.

Hereinafter, an embodiment according to the present invention will be described in detail with reference to the accompanying drawings. In describing with reference to the accompanying drawings, like reference numerals are given to like or corresponding components, and overlapped descriptions thereof will be omitted.

The present invention relates to a method of designing a conformal cooling channel inside a mold using deep learning and a topology optimization design.

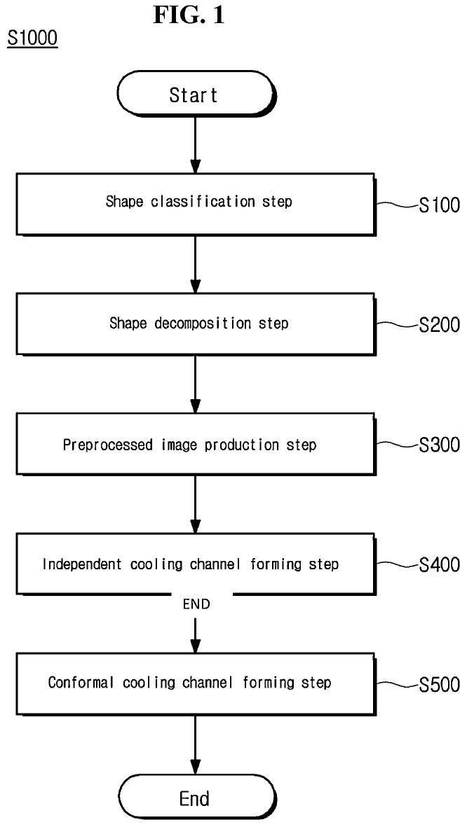

FIG. 1 is a flowchart illustrating a conformal cooling channel design method using deep learning and a topology optimization design according to an embodiment of the present invention.

A conformal cooling channel design method (S1000) using deep learning and a topology optimization design according to an embodiment of the present invention includes a shape classification step (S100), a shape decomposition step (S200), a preprocessed image production step (S300), an independent cooling channel forming step (S400), and a conformal cooling channel forming step (S500).

The shape classification step (S100) is a step of classifying a molded product as a bulk structure or a thin structure in order to determine a cooling target surface. That is, a shape of a cavity corresponding to the shape of a molded product is classified as a thin shape or a bulk shape.

In the present embodiment, a shape according to temperature deviation in a cooling process is classified based on a morphological characteristic of increasing a cooling amount as an area contacting with a cooling channel increases in the process of cooling an object. That is, even in the case of molded products of the same shape, the cooling target area varies according to the case of a thin structure or a bulk structure. Therefore, at the shape classification step (S100), it is determined whether a molded product is a thin structure or a bulk structure.

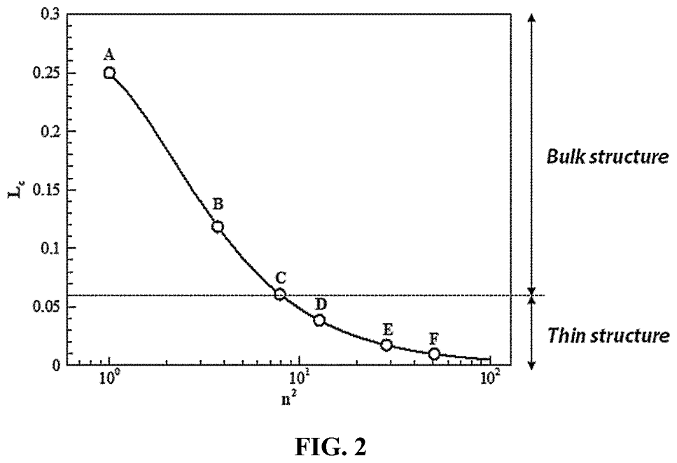

In the present embodiment, a characteristic length of a molded product is used as a criterion for determining whether the molded product is a thin structure or a bulk structure. More specifically, in the present embodiment, when the characteristic length is smaller than 0.06, the molded product is classified as a thin structure, and when the characteristic length is 0.06 or larger, the molded product is classified as a bulk structure. (See FIG. 2)

This is described below using a hexahedron shape as an example.

The length of the long side is defined as n and the length of the short side is defined as 1/n so that the cross-sectional area is 1 on the basis of the cross section of a hexahedron.

In this case, the characteristic length is

$${L}_{C} = \frac{A}{P} = \frac{n}{2 {n}^{2} - 1} .$$

Here, L_{C} is the characteristic length, A is the cross-sectional area, and P is the perimeter of the cross-section.

Here, when L_{C} is smaller than 0.06, it is classified as a thin structure.

When a hexahedron is divided into six types as shown below in [Table 1], A, B, and C are classified as a bulk structure in the present embodiment since the characteristic length is 0.06 or more, and D, E, and F are classified as a thin structure in the present embodiment since the characteristic length is smaller than 0.06.

TABLE 1

| | Volume/depth (L × H) | |
|---|---|---|
| Case | [mm²] | Ratio (n²:1) |
| A | 14.03 × 14.03 | 1:1 |
| B | 24.6 × 8 | 3.705:1 |
| C | 39.366 × 5 | 7.873:1 |
| D | 50 × 3.9365 | 12.70:1 |
| E | 75 × 2.6244 | 28.58:1 |
| F | 100 × 1.9683 | 50.81:1 |

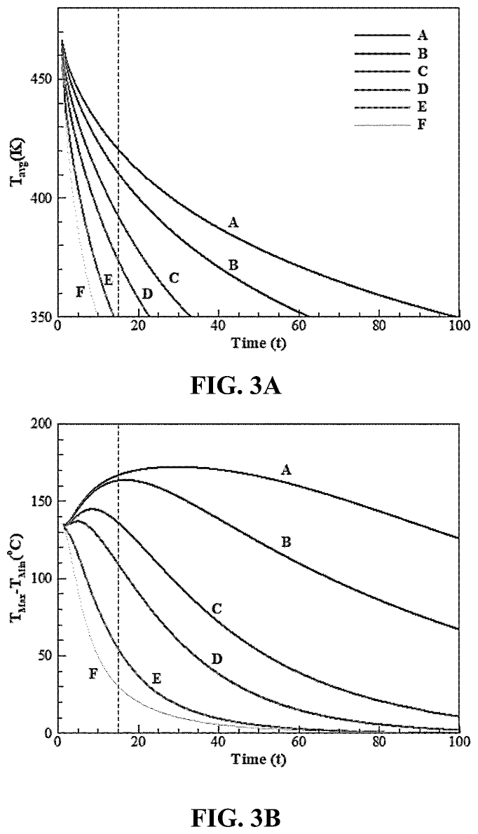

When the hexahedron is classified as a thin structure, the cooling target area is the top surface and the bottom surface, and when the hexahedron is classified as a bulk structure, the cooling target surface is the top surface, the bottom surface, and both side surfaces. Based on this, as a result of the experiment, it can be confirmed that the more the hexahedron is close to a thin structure (E, F), the shorter the average cooling time up until the ejection temperature (see FIG. 3A), and the smaller the maximum temperature deviation (see FIG. 3B).

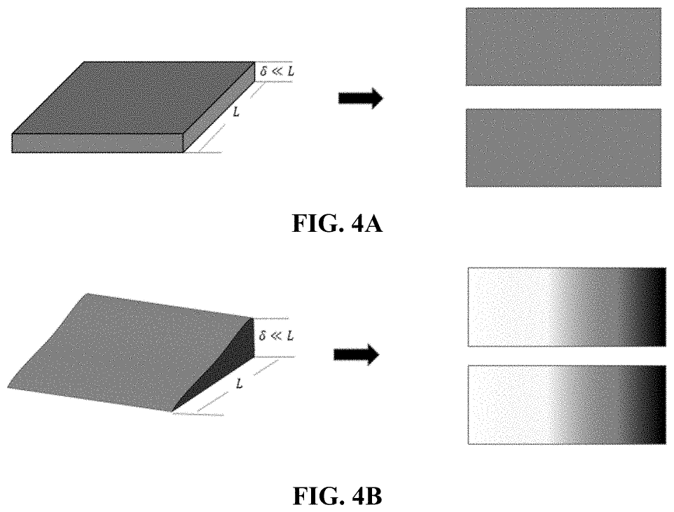

FIGS. 4A-4B are views describing a shape decomposition step.

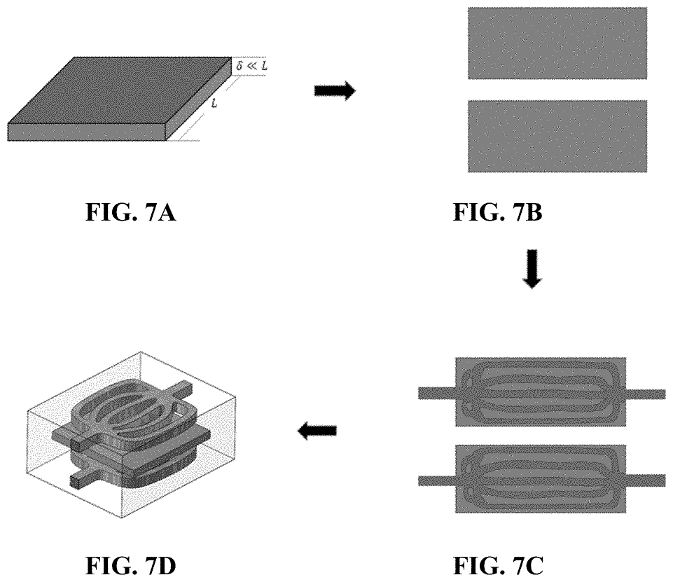

The shape decomposition step (S200) is a step of decomposing a cooling target area determined according to the (bulk/thin) shape of a molded product determined at the shape classification step (S100) into cooling target surfaces, which are two-dimensional shapes. (see FIGS. 7A and 7B) Here, the cooling target surface is the same as the surface of the cooling target area.

The preprocessed image production step (S300) is a step of producing a preprocessed image that is input into a previously trained neural network so that cooling channels independent from each other, to which a topology optimization design is applied, may be formed for each cooling target surface. (see FIG. 7C)

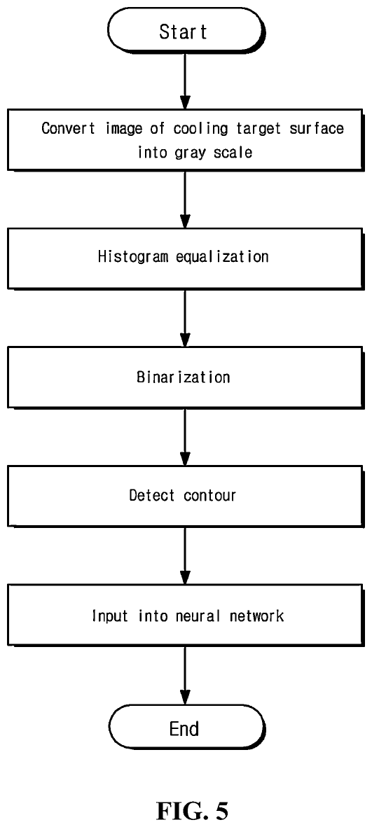

FIG. 5 is a flowchart illustrating a preprocessed image production step.

First, three-dimensional shape information is reflected in the image of the cooling target surface, which is a two-dimensional shape. This is to reflect a thermal load on the two-dimensional shape.

When the thickness is uniform along the flowing direction of a cooling fluid like a cuboid or a cube, it may be assumed that the cooling amount required for each area of the two-dimensional shape is the same (see FIG. 4A). However, when the thickness of the shape of the molded product is not uniform along the flowing direction of the cooling fluid, the cooling amount required for each area of the two-dimensional shape may be different.

Accordingly, although the cooling target surface is a two-dimensional shape, three-dimensional shape information is reflected to take into account the difference in the cooling amount according to the different thickness of each area. (See FIG. 4B) In the present embodiment, three-dimensional shape information is reflected on the assumption that a thermal load is applied in proportion to the thickness of each area of the cooling target surface. In other words, it is assumed that thickness information of the molded product is reflected on the cooling target surface of two-dimensional shape, and the required cooling amount varies according to the thickness information of the two-dimensional shape.

A preprocessed image is produced by performing a preprocessing step on the image of the cooling target surface to which a thermal load is reflected, and the preprocessed image is input into a previously trained artificial intelligence neural network. The preprocessing step is for removing noise in the image and enhancing the training effect using a convolutional neural network.

The preprocessing step may generate a second image by converting the input image into a gray scale image. The gray scale conversion process is a process of converting an input image, which is a color image, into a gray scale. The image of the cooling target surface to which a thermal load, which is the input image, is reflected is a color image having a different color according to the thermal load, and the RGB values of the color image may be changed to gray scale values. Through this, the amount of computation can be reduced by three times or more when the convolutional neural network is trained.

Thereafter, a third image may be generated by performing histogram equalization on the second image. The histogram equalization evenly distributes an image histogram concentrated at one place by equalizing the contrast of the gray-scaled second image. When the histogram of an image is concentrated only in a specific range, a corresponding image contrast is lowered, and the neural network performance is adversely affected. Therefore, the histogram equalization is performed to correct the histogram concentrated in a specific range of an image to be uniformly distributed.

Then, a binarized fourth image is generated by performing binarization/thresholding on the third image.

Thereafter, a contour of the fourth image is detected. The contour means a line connecting the points having the same value. That is, the contour may be a line connecting the points having the same thermal load and an outline of a cooling target surface. The contour may be detected from a binarized image using a Canny Edge Detection technique or using the method ‘findContours( )’ of Open Source Computer Vision (OpenCV).

The preprocessed image, which is an image whose contour is detected through the steps described above, is input into a previously trained neural network to form cooling channels independent form each other, to which a topology optimization design is applied, for each cooling target surface.

In this embodiment, the neural network may be a Convolutional Neural Network (CNN).

The neural network may be trained using a plurality of learning data. The learning data may include a two-dimensional learning image, to which a thermal load is reflected, and shape data of a cooling channel formed using a topology optimization design for the learning image.

In other words, in order to train a neural network for forming a cooling channel, labeling on a data set is required. Labeling is defining the shape of a cooling channel formed using a topology optimization design for the learning image.

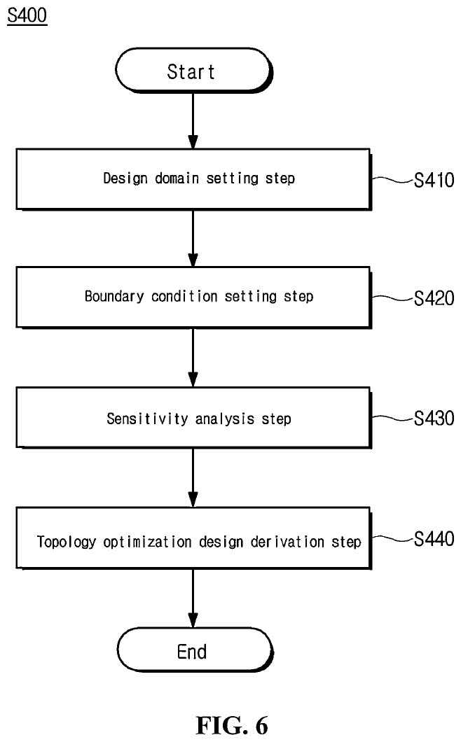

FIG. 6 is a flowchart illustrating an independent cooling channel forming step, and FIG. 7 is a view showing a conformal cooling channel forming step.

The topology optimization design for forming a cooling channel includes a design domain setting step (S410), a boundary condition setting step (S420), a sensitivity analysis step (S430), and a topology optimization design derivation step (S440).

First, a design domain is set. In the present embodiment, the design domain is a cooling target surface. That is, it is a cooling target surface of two-dimensional shape to which three-dimensional shape information is reflected.

Then, boundary conditions are set. In the present embodiment, the boundary conditions are the boundary of the cooling target surface, the diameters and positions of the inlet and the outlet, and the flow rate of the cooling fluid at the inlet and the outlet.

Thereafter, an objective function is set. Then, a topology optimization design may be derived by changing the design variables so that the objective function satisfies convergence conditions.

At this point, sensitivity analysis of each element may be performed for the objective function. The topology optimization design may be derived by repeating the process until the objective function satisfies the convergence conditions while changing the design variables of each element of the objective function according to sensitivity.

In the present embodiment, the objective function is for minimization of pressure drop of cooling fluid at the inlet and the outlet, and cooling time up until the ejection temperature.

That is, the objective function is to minimize the flow loss and the cooling time.

In the present embodiment, the objective function is a multi-objective function and may be defined as follows.

Minimize: c=0.5×log(Φ))+0.5×log(Γ)

Here, c is the multiple objective function, Φ is the objective function related to minimization of pressure drop, and Γ is the objective function related to minimization of cooling time.

Then, Φ and Γ may be defined as follows, respectively.

Φ=1/2μ∫_{Ω}∇u·∇udΩ+1/2∫_{Ω}α(ρ)u·udΩ−∫_{Ω}f·udΩ

Here, μ is the fluid dynamic viscosity, u is the velocity field, ρ is the pseudo-density, α is the darcy friction coefficient or inverse permeability, and f is the fluid body force, and Ω is the design area (shape domain).

Γ=1/2∫_{Ω}[k∇T·∇VT+ρₘcₚ(u·∇T)]d≠−∫_{Ω}−∫_{Ω}f_{τ}TdΩ

Here, k is the equivalent thermal conductivity, T is the temperature field, ρₘ is the equivalent density, cₚ is the equivalent heat capacity, f_{T} is the heat source, u is the velocity field, and Ω is the design area (shape domain).

Sensitivity analysis means analyzing the effect of the objective function according to the change in the design variables in order to derive a topology optimization design.

At the conformal cooling channel forming step (S400), each independent cooling channel is rearranged to correspond to the shape of the molded product to finally form a conformal cooling channel. (see FIG. 7D)

It may take a long time as the thermal load is reflected on the cooling target surface and the calculation amount is very large in forming a cooling channel using a topology optimization design for each cooling target surface. However, as a neural network forms a cooling channel, to which a topology optimization design is applied, from the image of the cooling target surface to which a thermal load is reflected through learning, the time can be greatly reduced. Furthermore, as the conformal cooling channel is designed using a topology optimization design as described above, the pressure drop, cooling time, and cooling uniformity are excellent.

### Experimental Example 1

A conformal cooling channel is designed for a molded product of a cuboid shape as a thin structure, and pressure drop of channel flow, maximum temperature difference, and cooling time up until the ejection temperature are measured.

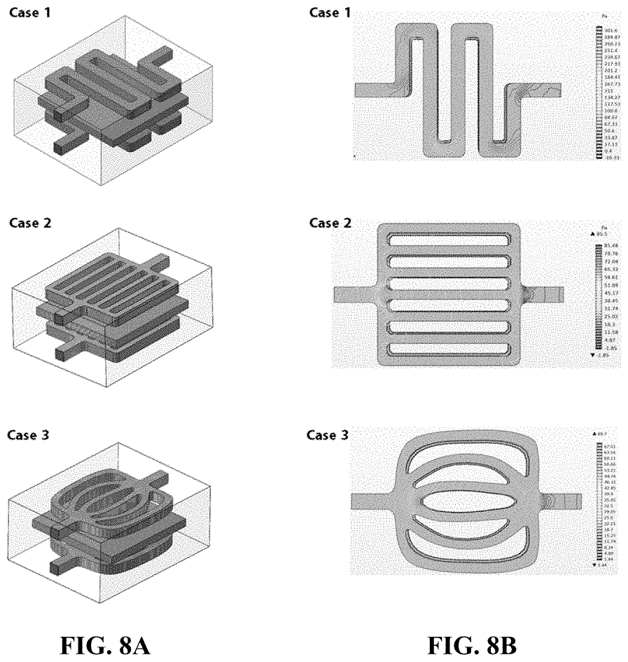

A serial-shaped conformal cooling channel (case 1), a parallel-shaped conformal cooling channel (case 2), and a conformal cooling channel using a topology optimization design according to the present embodiment (case 3) are designed and compared. (See FIG. 8A)

TABLE 2

| case | Average pressure drop of channel flow |
|---|---|
| 1 | 301.6 Pa |
| 2 | 85.5 Pa |
| 3 | 31.3 Pa |

TABLE 3

| case | Maximum temperature difference |
|---|---|
| 1 | 205.1 K |
| 2 | 179.5 K |
| 3 | 174.9 K |

TABLE 4

| case | Cooling time reaching ejection temperature (70° C.) |
|---|---|
| 1 | 3.5 s |
| 2 | 1.1 s |
| 3 | 0.8 s |

[Table 2] shows comparison of pressure drop of channel flow, [Table 3] shows comparison with the maximum temperature difference of the conformal cooling channel, and [Table 4] shows comparison of cooling time up until the ejection temperature. Referring to [Table 2] and FIG. 8B, it can be confirmed that pressure drop of the conformal cooling channel (case 3) using a topology optimization design according to the present embodiment is remarkably smaller than those of case 1 and case 2.

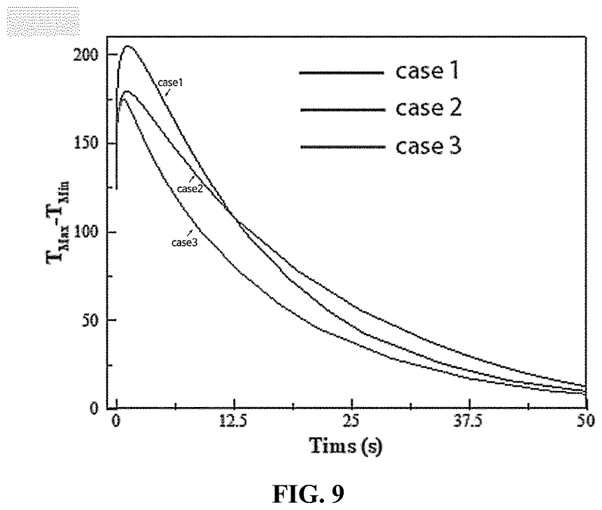

In addition, referring to [Table 3] and FIG. 9, it can be confirmed that in the case of the conformal cooling channel (case 3) using a topology optimization design according to the present embodiment, the maximum temperature difference is 30.2K smaller than that of case 1 and 4.6K smaller than that of case 2.

In addition, referring to [Table 4], in the case of the conformal cooling channel (case 3) using a topology optimization design according to the present embodiment, it can be confirmed that the cooling time up until the ejection temperature (70° C.) is 0.8s, which is 2.7s faster than that of case 1 and 0.3s faster than that of case 2.

### Experimental Example 2

A conformal cooling channel is designed for a molded product of a shape gradually decreasing in thickness as a thin structure, and pressure drop of channel flow and the maximum temperature difference are measured.

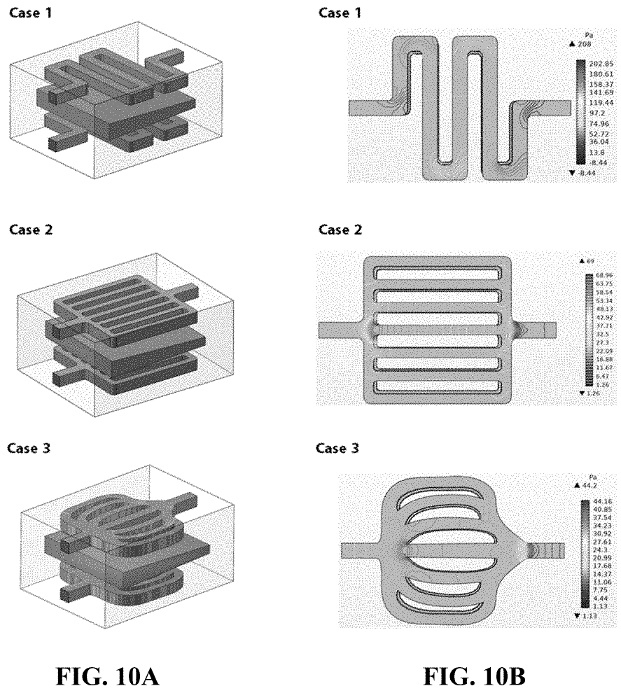

A serial-shaped conformal cooling channel (case 1), a parallel-shaped conformal cooling channel (case 2), and a conformal cooling channel using a topology optimization design according to the present embodiment (case 3) are designed and compared. (See FIG. 10A)

TABLE 5

| case | Average pressure drop of channel flow |
|---|---|
| 1 | 208.0 Pa |
| 2 | 69.0 Pa |
| 3 | 44.2 Pa |

TABLE 6

| case | Maximum temperature difference |
|---|---|
| 1 | 212.3 K |
| 2 | 211.2 K |
| 3 | 205.3 K |

[Table 5] shows comparison of pressure drop of channel flow, and [Table 6] shows comparison of maximum temperature difference. Referring to [Table 5] and FIG. 10B, it can be confirmed that pressure drop of the conformal cooling channel (case 3) using a topology optimization design according to the present embodiment is remarkably smaller than those of case 1 and case 2.

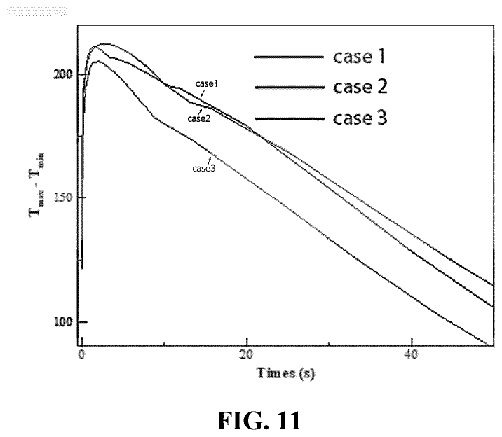

In addition, referring to [Table 6] and FIG. 11, it can be confirmed that in the case of the conformal cooling channel (case 3) using a topology optimization design according to the present embodiment, the maximum temperature difference is 7K smaller than that of case 1 and 5.9K smaller than that of case 2.

### Experimental Example 3

A cooling channel is designed for a molded product of a cosmetic container shape, and pressure drop of channel flow, maximum temperature difference on the surface of the molded product, and cooling time up until the ejection temperature are measured.

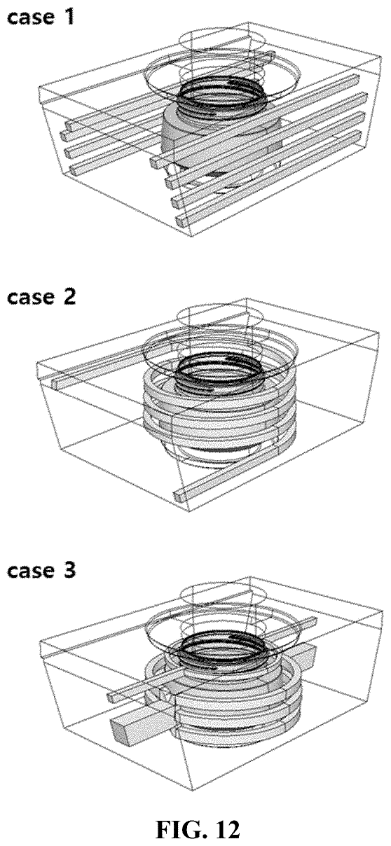

A straight cooling channel (case 1) that can be manufactured in a mechanical method of forming a conventional cooling channel, a helical-shaped cooling channel (case 2), and a conformal cooling channel using a topology optimization design according to the present embodiment (case 3) are designed and compared. (See FIG. 12)

TABLE 7

| | case 1 | case 2 | case 3 |
|---|---|---|---|
| Pressure drop (Pa) | 884.4 | 161,288.5 | 2050.7 |

[Table 7] shows comparison of pressure drop of channel flow. Referring to [Table 7], it can be confirmed that pressure drop inside the cooling channel of the conformal cooling channel using a topology optimization design according to the present embodiment (case 3) is about 80 times lower than that of the helical-shaped cooling channel (case 2).

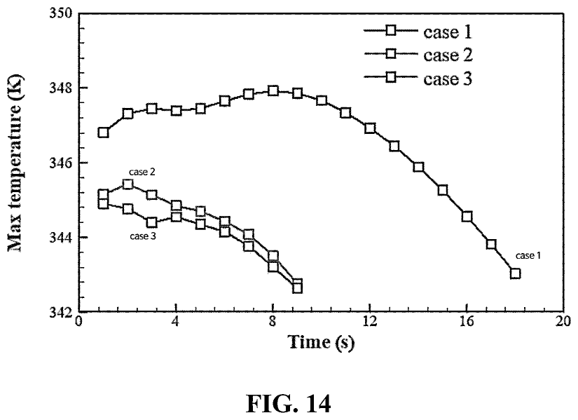

In addition, as a result of measuring the cooling time up until the ejection temperature assuming ejection of the molded product when the maximum ejection temperature (70° C.) of the surface is reached, it can be confirmed that the cooling time required to reach the ejection temperature is about 18 seconds in case 1, and about 8 seconds in the case of the helical-shaped cooling channel (case 2) and the conformal cooling channel (case 3) using a topology optimization design according to the present embodiment (see FIG. 14).

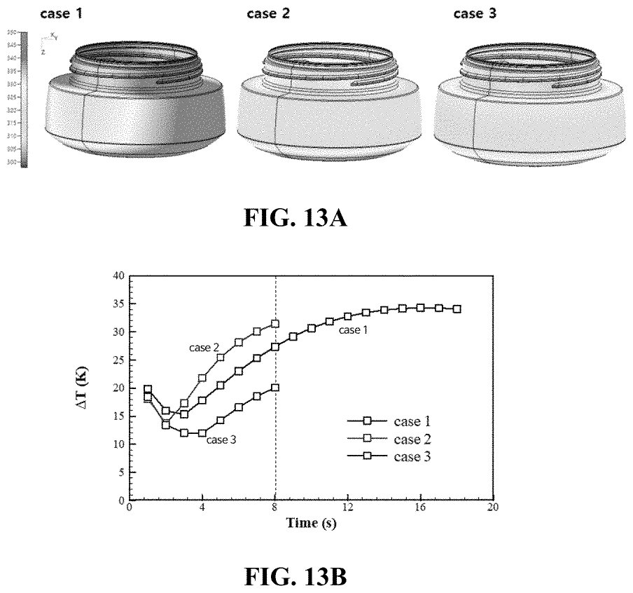

In addition, difference in the surface temperature is analyzed in order to compare the production time of the molded product and the deformation caused by residual stress. (see FIG. 13A)

It is confirmed that the maximum temperature difference on the surface of the molded product at 8 seconds, which is the ejection time of the helical-shaped cooling channel and the conformal cooling channel using a topology optimization design according to the present embodiment, is 31.425° C. in the case of the helical-shaped cooling channel, which is about 1.57 times larger than that of the present embodiment. Therefore, in the case of the present embodiment, the production time can be shortened by about 10 seconds faster than that of case 1 of the conventional method, and deformation caused by the residual stress can be minimized (see FIG. 13B).

Through the conformal cooling channel design method (S1000) using a topology optimization design as described above, a mold having a conformal cooling channel formed therein can be manufactured. Specifically, the conformal cooling channel can be designed by deriving an optimal result through a topology optimization design and may be converted in an STL format for additive manufacturing. Here, the additive manufacturing may be performed using a 3D printer of selective laser sintering (SLS) or binder-jet. The conformal cooling channel can be precisely manufactured through the 3D printer even when the conformal cooling channel has a complex hollow structure.

As described above, according to the present embodiment, there is provided a method of designing a conformal cooling channel inside a mold after determining a cooling target surface by classifying a molded product as a bulk structure or a thin structure and forming an independent cooling channel to which a topology optimization design is applied using deep learning of a neural network for each cooling target surface.

The use of all examples or exemplary terms (e.g., etc.) in the present invention is merely for the purpose of describing the present invention in detail, and unless limited by the claims, the scope of the present invention is not limited by the examples or exemplary terms. In addition, those skilled in the art may know that the examples or exemplary terms may be configured according to design conditions and factors within the scope of the claims, to which various modifications, combinations, and changes are added, or equivalents thereof.

Therefore, the spirit of the present invention should not be limited to the embodiments described above, and all ranges equivalent to or changed from these claims, as well as the claims described below, are within the scope of the spirit of the present invention.

### INDUSTRIAL APPLICABILITY

A method of designing a conformal cooling channel inside a mold using deep learning and a topology optimization design is provided.

1. A conformal cooling channel design method using deep learning and a topology optimization design, the method comprising the steps of:
classifying a molded product as a thin structure or a bulk structure, and determining a cooling target area;
decomposing the cooling target area into cooling target surfaces of two-dimensional shape;
producing a preprocessed image by performing a preprocessing step on an image of the cooling target surface to which a thermal load is reflected;
forming cooling channels independent from each other, to which a topology optimization design is applied, for each of the cooling target surfaces by inputting the preprocessed image into a previously trained neural network; and
forming a conformal cooling channel by combining the cooling channels.

2. The method according to claim 1, wherein the step of producing a preprocessed image includes the steps of:
generating a second image by converting the image of the cooling target surface, to which the thermal load is reflected, into a gray scale image;
generating a third image by performing histogram equalization on the second image;
generating a binarized fourth image by performing binarization/thresholding on the third image; and
detecting a contour of the fourth image, wherein
the preprocessed image is an image of which the contour is detected.

3. The method according to claim 2, wherein the neural network is a Convolutional Neural Network (CNN).

4. The method according to claim 3, wherein the neural network is trained using a plurality of learning data, and the learning data includes a learning image to which a thermal load is reflected, and shape data of a cooling channel formed using a topology optimization design for the learning image.

5. The method according to claim 4, wherein the topology optimization design includes the steps of:
setting a design domain;
setting boundary conditions corresponding to operating conditions of the design domain;
setting an objective function corresponding to minimization of pressure drop of cooling fluid at an inlet and an outlet, and cooling time up until an ejection temperature; and
changing design variables so that the objective function satisfies a convergence condition.

6. The method according to claim 1, wherein at the step of determining a cooling target surface, the molded product is classified as a thin structure when a characteristic length of the molded product is smaller than 0.06.
